(19) United States
(12) Patent Application Publication
(10) Pub. No.: US 2020/0263634 A1
(43) Pub. Date: Aug. 20, 2020

(54) THRUST REVERSER WITH A SYSTEM FOR LOCKING AND UNLOCKING UNDER LOAD

(71) Applicant: Safran Nacelles, GONFREVILLE L'ORCHER (FR)

(72) Inventors: Denis GUILLOIS, MOISSY CRAMAYEL (FR); Loïc CHAPELAIN, GONFREVILLE L'ORCHER (FR)

(73) Assignee: Safran Nacelles, GONFREVILLE L'ORCHER (FR)

(21) Appl. No.: 16/859,028

(22) Filed: Apr. 27, 2020

Related U.S. Application Data
(63) Continuation of application No. PCT/FR2018/052662, filed on Oct. 26, 2018.

(30) Foreign Application Priority Data
Oct. 27, 2017 (FR) 1760179

(51) Int. Cl. F02K 1/76; F02K 1/72

(52) U.S. Cl. CPC F02K 1/766; F02K 1/72

(57) ABSTRACT

A lock for a cowl of a thrust reverser borne by a nacelle includes a striker fixed on the cowl, a hook that is configured to engage the striker and is elastically returned towards engagement with the striker, and a support fixed on the nacelle and supporting a locking/unlocking component interposed between the hook and the support. The locking/unlocking component is configured to allow, on the one hand, the hook to move in relation to the support between a locking position, in which the hook is engaged with the striker and exerts a pressure thereon, and a unlocking position, in which the hook is disengaged from the striker or is simply in contact therewith, and to allow, on the other hand, the hook to tilt in order to disengage it from the striker or engage it therein.

### CROSS-REFERENCE TO RELATED APPLICATIONS

This application is a continuation of International Application No. PCT/FR2018/052662, filed on Oct. 26, 2018, which claims priority to and the benefit of FR 17/60179 filed on Oct. 27, 2017. The disclosures of the above applications are incorporated herein by reference.

### FIELD

The present disclosure relates to a lock for a cowl of a thrust reverser of a nacelle, an application of the lock to a cascade-type or door-type nacelle, and a method for unlocking the lock.

### BACKGROUND

The statements in this section merely provide background information related to the present disclosure and may not constitute prior art.

The cowls of thrust reversers of the cascades—(sliding cowls), or doors—(rotary cowls) type, comprise cylinders for actuating the cowls, and locks allowing holding these cowls in the closed position without loading the actuation cylinders as long as it is not desired to use the thrust reversal function.

Conventionally, these locks comprise a hook rotatably mounted on a support connected to the nacelle, according to a configuration enabling a cooperation of the hook with a striker secured to the movable cowl.

When it is desired to open the movable cowl in order to use the thrust reversal function, one should start by controlling the actuation cylinders of this cowl so as to constrain it towards an over-closed position for which it is possible to clear the hook from the striker, and then controlling the actuation cylinders to bring the cowls into their operating position as thrust reversers.

This operation of controlling the movable cowl into the over-closed position requires an oversizing of the actuation cylinders, and the arrangement of clearances enabling the displacement of the cowl towards the over-closed position.

Furthermore, the passage from the closed position into the over-closed position and the return to the closed position from which the opening itself begins, prolong the time of the unlocking cycle and therefore retard the activation of the thrust reversal function. This delay is particularly critical in aborted landing or takeoff situations.

### SUMMARY

This section provides a general summary of the disclosure and is not a comprehensive disclosure of its full scope or all of its features.

The present disclosure provides a lock for a cowl of a thrust reverser whose implementation is quicker than that of the existing locks.

The present disclosure provides a lock for a cowl of a thrust reverser carried by a nacelle, the lock comprising: a striker fastened to the cowl; a hook configured to be engaged into the striker and elastically biased into engagement with the striker; and a support fastened to the nacelle and carrying a locking/unlocking member interposed between the hook and said support fastened to the nacelle, said locking/unlocking member being configured to enable on the one hand a displacement of the hook relative to said support fastened to the nacelle between a position called locking position for which the hook is engaged into the striker and exerts a bearing thereon and a position called unlocking position for which the hook is cleared from the striker or simply in contact therewith, and on the other hand a tilting of the hook to clear it from the striker or engage it therein.

Thus, the hook is cleared from the striker without having to bring the cowl into the over-closed position. Consequently, the unlocking time of the cowl is reduced to the displacement time of the hook, that is to say a time substantially corresponding to a time of passage of the cowl from the closed position into the over-closed position. Hence, the lock according to the present disclosure allows saving a time substantially equal to the time of return of the cowl from the over-closed position to the closed position. Furthermore, the actuation cylinders of the cowl are no longer used for unlocking the lock so that the dimension of the actuation cylinders may be reduced.

According to an advantageous version of the present disclosure, the locking/unlocking member is pivotally mounted on said support fastened to the nacelle, the hook and the locking/unlocking member are configured to form a connecting rod/crank assembly, and the tilting of the hook is provided by a cam fastened to the locking/unlocking member. Thus, the displacement of the hook is achieved with as less frictions as possible, which allows using components with reduced dimensions.

According to one form of the present disclosure, the locking/unlocking member includes a gear wheel associated to a worm screw driven by a motor fastened to said support fastened to the nacelle.

According to another form of the present disclosure, the locking/unlocking member is connected to a hydraulic cylinder.

In another form, the lock includes two locking/unlocking members each associated to one hook, and an actuation member common to both locking/unlocking members.

Thus, the number of components employed for carrying out the present disclosure is reduced.

According to another aspect of the present disclosure, it concerns a cascade-type or door-type nacelle, including a lock according to the present disclosure associated to at least one cascade or one door.

Still according to another aspect of the present disclosure, it concerns a method for unlocking a lock according to the present disclosure wherein, starting from a locking position of the lock, for which at least one hook is engaged into at least one striker and is pressed thereon with a force called locking force, the method includes the steps of controlling a displacement of said at least one hook according to a direction adapted to reduce the force applied to said at least one striker, and then performing a tilting of said at least one hook in a direction releasing said at least one striker.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of the lock according to a first form of the present disclosure, in the locking position;

FIG. 2 is a schematic representation similar to that of FIG. 1 after displacement of the hooks to reduce the bearing force of the hooks on the strikers;

FIG. 3 is a schematic representation similar to that of FIG. 1 after tilting of the hooks;

FIG. 4 is a schematic representation similar to that of FIG. 1 at the end of the unlocking cycle; and

FIG. 5 is a schematic representation similar to that of FIG. 1 of a second form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

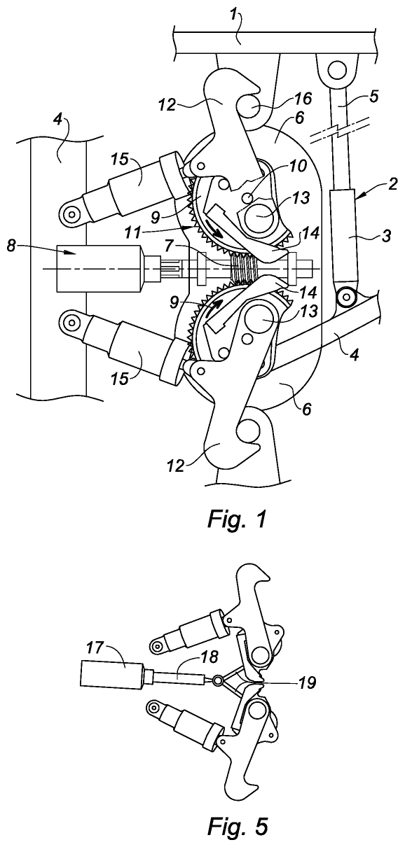

Referring to FIGS. 1 to 4, a lock 25 is intended to provide the locking/unlocking of a cowl 1 of a thrust reverser. In a manner known per se, the cowl 1 is associated to an actuation cylinder 2 whose body 3 is connected to the carrier structure 4 of the nacelle, and whose rod 5 is hingedly connected to the cowl 1. In a manner also known per se, a striker 16 is fastened to the cowl 1. The striker 16 is configured to receive a hook.

According to the illustrated form, the lock 25 is intended to provide the simultaneous locking/unlocking of two cowls 1 by a common actuation member. To this end, the lock 25 includes a case 6 fastened to the carrier structure 4 and including a central portion configured to receive a worm screw 7 connected to a drive motor 8. Symmetrically with respect to the worm screw, the case 6 includes two compartments each containing a locking/unlocking member comprising a wheel 9 mounted so as to rotate about an axis 10 carried by the case 6 and including a toothed sector 11 engaged with the worm screw 7, and a hook 12 pivotally mounted about an axis 13 carried by the corresponding gear wheel 9 and offset with respect to the gear wheel. Hence, each hook 12 constitutes, together with the corresponding wheel, a connecting rod/crank assembly. A cam 14 whose positioning and function will be described later on, is rigidly fastened to the gear wheel 9. Moreover, each hook 12 is connected to one end of an elastic member 15 whose other end is fastened to the carrier structure 4 of the nacelle. The elastic member 15 is configured to exert on the hook 12 an action for biasing the hook towards the corresponding striker.

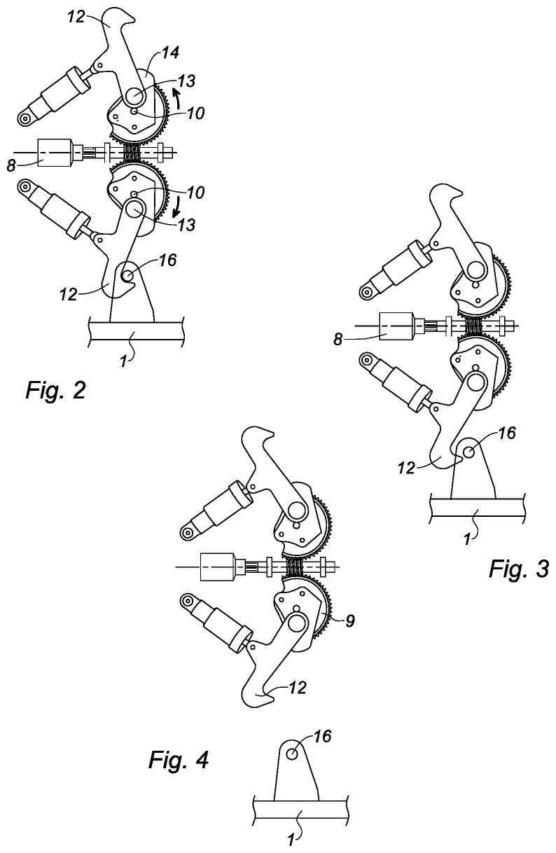

In FIG. 1, the lock 25 is illustrated in the locking position of the cowls, that is to say the hooks 12 are engaged into the striker 16, and for each set, the bearing point on the striker 16, the pivot axis 10 of the wheel 9 and the pivot axis 13 of the hook 12, are almost aligned, with the axis 10 between the axis 13 and the free end of the hook 12. This alignment configuration allows reducing, and in one form even canceling, the torque on each gear wheel 9. The length of the hooks 12 and the distance between the axes 10 and 13 are calculated so that the hooks 12 are then firmly pressed on the striker 16. Starting from this position, a rotation of the wheels 9 in a direction of disengagement of the hooks as indicated by the arrows in thick line in FIG. 1, causes a deployment of the connecting rod/crank assembly until the bearing point on the striker 16, the pivot axis 10 of the wheel 9 and the pivot axis 13 of the hook 12, are again almost aligned, but this time with the axis 13 between the axis 10 and the free end of the hook 12 as illustrated in FIG. 2. The bearing of the hooks 12 on the striker 16 is then reduced to a simple contact. Moreover, the positioning of the cam 14 is determined so that in this situation, and edge of the cam 14 turned towards the hook 12 bears on the side of the hook 12 as illustrated in FIG. 2. Starting from this position, an additional rotation of the gear wheels causes a disengagement of the hooks 12 as illustrated in FIG. 3. The cowl 1 is then free to open as illustrated in FIG. 4. The continuation of the opening cycle is performed in a known manner under the control of the actuation cylinders. As regards FIGS. 2 to 4, it should be noted that for simplicity, the different positions of the cowl 1 are illustrated only on the lower portion of the drawings. Of course, the explanations provided for the lower position also apply to the upper portion.

As regards the locking of the cowls, these are brought by the actuation cylinders 2 up to the position for which the hooks 12 are engaged into the strikers 16.

The continuation of locking cycle is then performed by reversing the controls described for the unlocking.

FIG. 5 illustrates a second form of a lock 25′. In this form, the electric motor and the associated worm screw have been replaced by a hydraulic cylinder 17 having a rod 18 connected to the connecting rod/crank assembly by arms 19.

Of course, the present disclosure is not limited to the described form and is prone for variants yet without departing from the scope of the present disclosure as defined by the claims.

In particular, although the device according to the present disclosure has been described in connection with connecting rod/crank assemblies, the displacement of the hooks 12, in opposition with the over-closure of the cowls, may be performed by using other mechanisms, in particular rack mechanisms.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A lock for a cowl of a thrust reverser carried by a nacelle, the lock comprising:
a striker fastened to the cowl;
a hook configured to be engaged into the striker, wherein the hook is connected to one end of an elastic member having another end fastened to the nacelle to elastically bias the hook into engagement with the striker; and
a support fastened to the nacelle and carrying a locking/unlocking member interposed between the hook and the support, the locking/unlocking member being configured to enable a displacement of the hook relative to the support between a locking position in which the hook is engaged into the striker and exerts a bearing thereon and an unlocking position in which the hook is cleared from the striker, and a tilting of the hook to clear the hook from the striker or engage the hook in the striker.

2. The lock according to claim 1, wherein the locking/unlocking member is pivotally mounted on the support, the hook and the locking/unlocking member are configured to form a connecting rod/crank assembly, and the tilting of the hook is provided by a cam fastened to the locking/unlocking member.

3. The lock according to claim 2, wherein the locking/unlocking member includes a gear wheel associated to a worm screw driven by a motor fastened to the support.

4. The lock according to claim 2, wherein the locking/unlocking member is connected to a hydraulic cylinder.

5. The lock according to claim 1 further comprising two locking/unlocking members, each locking/unlocking member associated to one hook, and an actuation member common to the two locking/unlocking members.

6. A cascade-type or door-type nacelle comprising a lock according to claim 1.

7. A method for unlocking a lock according to claim 1, wherein the lock includes at least one hook engaged into at least one striker and pressed thereon with a locking force when the lock is in the locking position, the method comprising:
controlling a displacement of the at least one hook according to a direction adapted to reduce the force applied to the at least one striker; and
tilting the at least one hook in a direction releasing the at least one striker.
